(19) United States
(12) Patent Application Publication
(10) Pub. No.: US 2007/0061858 A1
(43) Pub. Date: Mar. 15, 2007

(54) Digital television receiving system

(75) Inventor: Kazuo Ura, Fussa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD.

(21) Appl. No.: 11/519,177

(22) Filed: Sep. 11, 2006

(30) Foreign Application Priority Data
Sep. 14, 2005 (JP) 2005-267115
Jun. 26, 2006 (JP) 2006-175451

(51) Int. Cl. H04N 7/173

(52) U.S. Cl. 725/112; 725/113

(57) ABSTRACT

A television receiver having an Internet connecting information function transmits information of a television program that a user is watching to a server on the Internet, and transmits a URL of a Web site accessed by the user while the user is watching the television program, to the server. The server receives the information that is transmitted to the server from the television receiver and the URL that is transmitted to the server from the television receiver, and collects the URL received in correspondence with program information. The collection result of URLs collected is output to a television broadcast station from the server and distributed to the television receiver via a television signal.

### CROSS-REFERENCE TO RELATED APPLICATIONS

This application is based upon and claims the benefit of priority from prior Japanese Patent Applications No. 2005-267115, filed Sep. 14, 2005; and No. 2006-175451, filed Jun. 26, 2006, the entire contents of both of which are incorporated herein by reference.

### BACKGROUND OF THE INVENTION

1. Field of the Invention

The present invention relates to a digital television receiving system for browsing the home pages of Web sites relevant to a terrestrial digital television broadcast program that a user is watching.

2. Description of the Related Art

Terrestrial digital television broadcasting has recently been put to practical use from urban areas to local areas. Television sets therefor have become widespread accordingly.

Communication devices for communicating with the Internet using a personal computer and the like are generally widespread. The communication devices allow a user to easily gain access to the Web sites relevant to the programs of television broadcasting established on the Internet.

There is a television set having both a function of receiving/transmitting digital television broadcast signals and a function of connecting and communicating with the Internet. If a user designates the URL of a relevant Web site displayed by characters on a television program that the user is watching, he or she can gain access to the relevant Web site and easily browse its home page. Such a television broadcasting system is disclosed in, for example, Jpn. Pat. Appln. KOKAI Publication No. 2002-112229.

In general, the audience rating of a television program is considered to be very important in producing the program. A large audience randomly selected in advance provides their information on trends in the program. However, the audience rating is not obtained from all the audience of the program. It is therefore desirable to collect browsing information about the home page of a Web site relevant to the program as well as the audience rating and use it effectively.

### BRIEF SUMMARY OF THE INVENTION

The present invention has been developed in consideration of the above situation and an object thereof is to provide a digital television receiving system capable of collecting Web site browsing information about a television program from all the audience of the program and using the information effectively, a receiver of the system, and a server of the system.

According to a first aspect of the present invention, there is provided a television receiving system including a television receiver having an Internet connecting function and a server on the Internet, the television receiver comprising: information transmitting means for transmitting information of a television program that a user is watching, to the server; and URL transmitting means for transmitting a URL of a Web site accessed by the user using the Internet connecting function while the user is watching the television program, to the server, and the server comprising: information receiving means for receiving the information that is transmitted to the server from the information transmitting means of the television receiver; URL receiving means for receiving the URL that is transmitted to the server from the URL transmitting means of the television receiver; access URL collecting means for collecting the URL received by the URL receiving means in correspondence with program information based on the information received by the information receiving means; and collection result outputting means for outputting a collection result of URLs collected by the access URL collecting means for each program information.

According to a second aspect of the present invention, there is provided a television receiver having an Internet connecting function, comprising: information transmitting means for transmitting information of a television program that a user is watching, to a server on the Internet; and URL transmitting means for transmitting a URL of a Web site accessed by the user using the Internet connecting function while the user is watching the television program, to the server on the Internet.

According to a third aspect of the present invention, there is provided a server to which a television receiver is connected, the television receiver including information transmitting means for transmitting information of a television program to the server on the Internet while a user is watching the television program and URL transmitting means for transmitting a URL of a Web site accessed by the user while the user is watching the television program, to the server on the Internet, the server comprising: information receiving means for receiving information from the information transmitting means of the television receiver; URL receiving means for receiving the URL that is transmitted to the server from the URL transmitting means of the television receiver; access URL collecting means for collecting the URL received by the URL receiving means in correspondence with program information based on the information received by the information receiving means; and collection result outputting means for outputting a collection result of URLs collected by the access URL collecting means for each program information.

### BRIEF DESCRIPTION OF THE SEVERAL VIEWS OF THE DRAWINGS

FIG. 1 is a block diagram of the entire configuration of a digital television receiving system according to a first embodiment of the present invention;

FIG. 2 is a block diagram of the configuration of a digital television receiver of the digital television receiving system according to the first embodiment;

FIG. 3 is a chart of some of different data memories reserved in a memory of the digital television receiver;

FIG. 4 is a table showing part of URL information for each of broadcast programs sequentially updated and stored in a shared database of a URL providing server and a collecting server in the digital television receiving system according to the first embodiment;

FIG. 5 is a flowchart showing a process of providing a URL by the URL providing server in the digital television receiving system according to the first embodiment;

FIG. 6 is a flowchart showing a television display process of the digital television receiver of the digital television receiving system according to the first embodiment;

FIG. 7 is a chart showing a state of a broadcast program video screen displayed by the television display process of the digital television receiver;

FIG. 8 is a flowchart showing a browser display process accompanying the television display process of the digital television receiver;

FIG. 9 is a flowchart showing an HP display monitoring process accompanying the television display process of the digital television receiver;

FIG. 10 is a flowchart showing a collection process performed by the collecting server of the digital television receiving system;

FIG. 11 is a chart showing a broadcast program video screen with a relevant HP access ranking message created by a broadcast station in accordance with the collection process performed by the collecting server of the digital television receiving system;

FIG. 12 is a table showing part of URL information and television operating information of a broadcast program, which is sequentially updated and stored in a shared database of a URL providing server and a collecting server in a digital television receiving system according to a second embodiment of the present invention;

FIG. 13 is a flowchart showing an HP display monitoring process accompanying a television display process of a digital television receiver of the digital television receiving system according to the second embodiment;

FIG. 14A is a chart showing a transmission format of newly-browsing URL data to be transmitted to the collecting server in accordance with an HP display monitoring process in the digital television receiver;

FIG. 14B is a chart showing a transmission format of browsed URL data to be transmitted to the collecting server in accordance with the HP display monitoring process in the digital television receiver;

FIG. 15 is a flowchart showing a TV operation monitoring process started up concurrently with a television display process of the digital television receiver;

FIG. 16 is a chart showing a transmission format of TV operation data to be transmitted to the collecting server in accordance with the TV operation monitoring process in the digital television receiver;

FIG. 17 is a flowchart showing a collection process of the collecting server of the digital television receiving system according to the second embodiment; and

FIG. 18 is a chart showing a broadcast program video screen with a relevant HP access ranking and audience trend message created by a broadcast station in accordance with the collection process performed by the collecting server of the digital television receiving system.

### DETAILED DESCRIPTION OF THE INVENTION

Embodiments of the present invention will be described with reference to the accompanying drawings.

(First Embodiment)

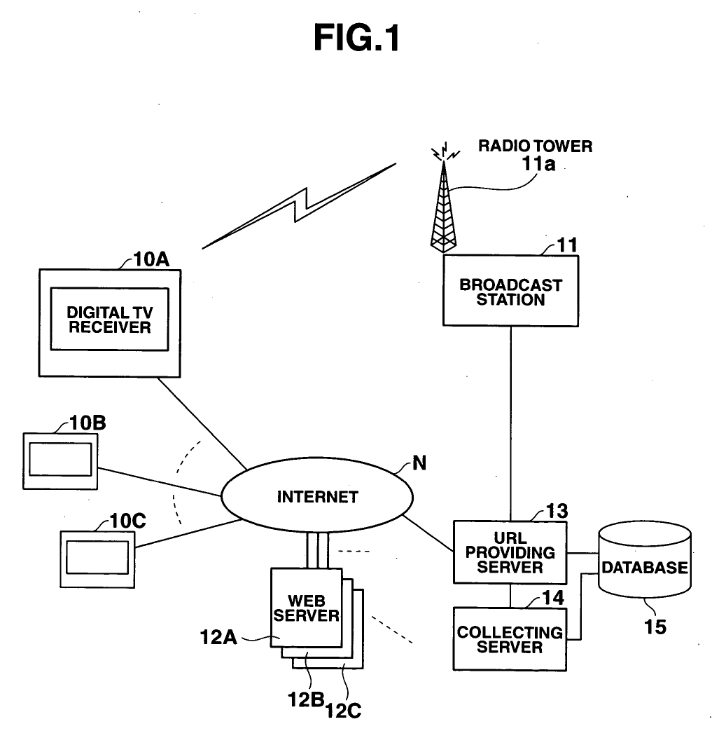

FIG. 1 is a block diagram of the entire configuration of a digital television receiving system according to a first embodiment of the present invention.

The digital television receiving system includes a number of digital television receivers such as receivers 10A, 10B and 10C shown in FIG. 1.

The digital television receivers 10A, 10B and 10C are each used by a general user. The receivers 10A, 10B and 10C receive a terrestrial digital television broadcast signal from a broadcast station 11 through its radio tower 11a and output it as video and voice. The receivers 10A, 10B and 10C have a function of communicating with the Internet N. When a user operates his or her receiver, the receiver gains access to various Web sites (servers) 12A, 12B and 12C established on the Internet N and outputs information of a Web page distributed from the Web sites (servers) 12A, 12B and 12C.

The Web sites (servers) 12A, 12B and 12C distribute information relevant to television broadcast programs produced by the broadcast station 11.

The digital television receiving system includes a URL providing server 13 and a collecting server 14 which are connected to the Internet N. A shared database 15 is connected to these servers 13 and 14.

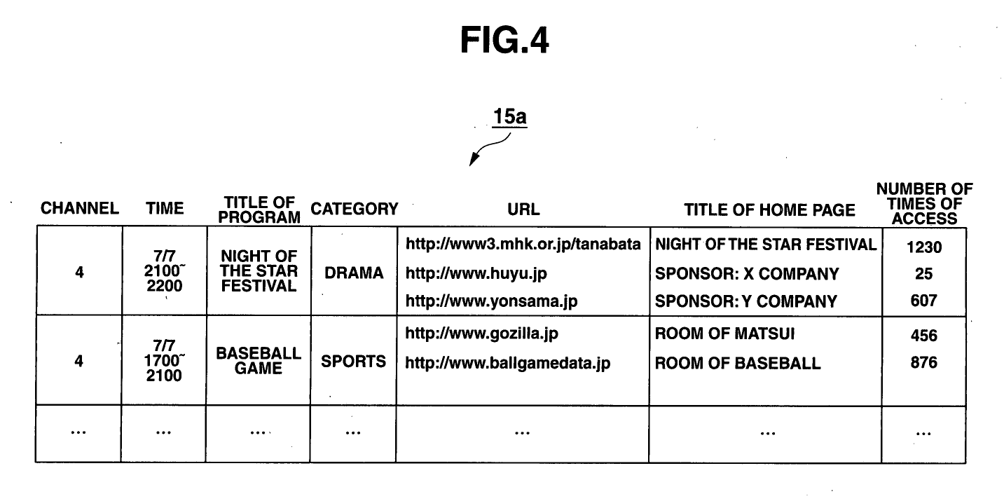

The URL providing server 13 receives URL information (see FIG. 4) of each of the Web sites 12A, 12B and 12C for distributing information relevant to broadcast programs from the broadcast station 11, and updates the database 15 to store the information. Upon receiving information of a program that a user is watching from the digital television receivers 10A, 10B and 10C, the URL providing server 13 retrieves URL information of the Web sites 12A, 12B and 12C relevant to the program from the database 15 and distributes the information.

The collecting server 14 receives access information of browsing Web sites (12A, 12b, 12C) from the digital television receivers 10A, 10B and 10C and collects the access information as the number of access times for each URL information (see FIG. 4) of the Web sites 12A, 12B and 12C stored in the database 15. The collecting server 14 provides the broadcast station 11 with access information for each of the Web sites 12A, 12B and 12C collected and stored in the database 15, and opens the access information to the public as Web information.

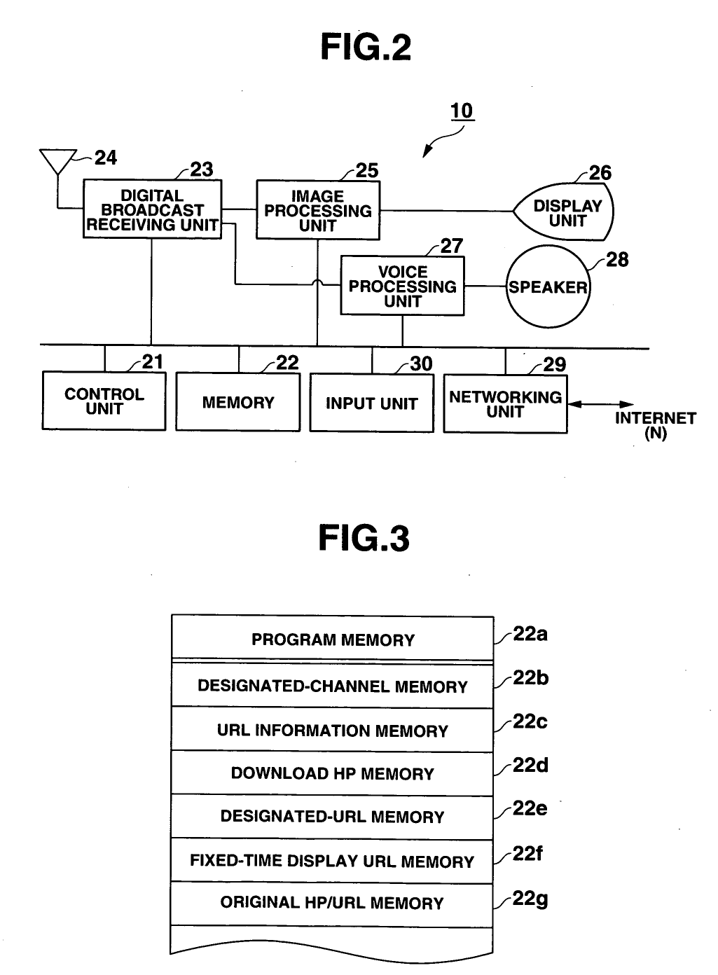

FIG. 2 is a block diagram showing a configuration of a digital television receiver 10 (one of the receivers 10A, 10B and 10C) in the digital television receiving system.

The digital television receiver 10 includes a control unit 21 that is formed of a CPU. The control unit 21 controls the operation of each unit in accordance with the unit control programs stored in a memory 22 such as a hard disk and a flash ROM to thereby start up a receiving/outputting section for receiving and outputting a terrestrial digital television broadcast and a communicating section for communicating with the Internet N.

The receiving/outputting section includes a digital broadcast receiving unit 23 to receive a terrestrial digital television broadcast signal via an antenna 24.

The image signal of a broadcast signal received by the digital broadcast receiving unit 23 is demodulated by an image processing unit 25 and displayed on a display unit 26 such as a liquid crystal panel. The voice signal of the received broadcast signal is also demodulated through a voice processing unit 27 and produced from a speaker 28.

Not only the memory 22, digital broadcast receiving unit 23, image processing unit 25, voice processing unit 27, but also a networking unit 29 and an input unit 30 are connected to the control unit 21.

The networking unit 29 communicates with the Web servers 12A, 12B, 12C, 13 and 14 on the Internet N under the control of the control unit 21 in accordance with the communication programs stored in the memory 22.

The input unit 30 includes a power ON/OFF key, a broadcast channel selection key, a volume control key, a character/symbol input key, a cursor key, an enter/execution key.

FIG. 3 is a chart of some of different data memories reserved in the memory 22 of the digital television receiver 10. The data memories include a program memory 22a, a designated-channel memory 22b, a URL information memory 22c, a download HP memory 22d, a designated-URL memory 22e, a fixed-time display URL memory 22f and an origin HP/URL memory 22g.

The program memory 22a stores in advance a system program for performing the entire control operation of the digital television receiver 10, a television broadcast receiving program for receiving and outputting a television broadcast program, a communication program for accessing the Web sites on the Internet N, a browsing program for displaying data of a Web page distributed from a Web site that is being accessed and an HP display monitoring program for monitoring the state of an HP displayed by gaining access to the Web site.

The designate-channel memory 22b stores a channel number of a broadcast channel designated by a user's operation by the input unit 30.

The URL information memory 22c stores the URL of a Web site relevant to a program, which is distributed and provided from the URL providing server 13 in accordance with the user's designated broadcast channel and the present time.

The download HP(Home Page) memory 22d stores data of the HP downloaded from each of the Web sites 12A, 12B and 12C.

The designated-URL memory 22e stores the URL of a user's designated HP of a Web site relevant to a broadcast program, which is overlapped with an image of the program while the program is being displayed.

The fixed-time display URL memory 22f stores the URL of an HP that a user browses for longer than a fixed period of time by accessing the Internet N while the user is watching a broadcast program.

The origin HP/URL memory 22g stores the URL of an HP that is the origin of a plurality of home pages when a user accesses the Internet N and browses the home pages while the user is watching a broadcast program.

FIG. 4 is a table showing part of URL information 15a for each of broadcast programs sequentially updated and stored in the shared database 15 of the URL providing server 13 and the collecting server 14 in the digital television receiving system.

The URL information 15a contains a channel for each of the programs broadcasted by the broadcast station 11, the airdate, title and category of each of the programs, the URL of each Web site relevant to the programs, and the HP title corresponding to the URL, and the number of times the audience gains access to an HP while the audience is watching a program. The information of channel, airdate, title, category, Web site URL and HP title is updated by the URL providing server 13 as the information sent from the broadcast station 11 changes. The information of the number of HP access times is summarized and updated by the collecting server 14 on the basis of HP display browsing information sent from the digital television receivers 10A, 10B and 10C.

An operation of the above digital television receiving system according to the first embodiment will be described.

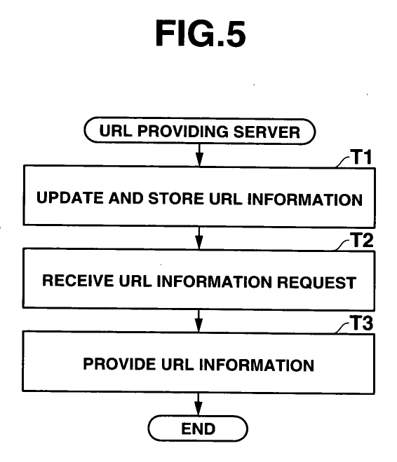

FIG. 5 is a flowchart showing a process of providing a URL by the URL providing server 13 in the digital television receiving system.

When the URL information 15a (FIG. 4) of channel, airdate, title, category, Web site URL and HP title, which is stored in the shared database 15, is changed, the URL providing server 13 updates and stores the changed information (step T1).

When the URL providing server 13 receives a request for URL information including the received channel of a program that a user is watching and the present time from the digital television receiver 10 (step T2), it reads the URL of a Web site relevant to the program from the URL information 15a stored in the shared database 15 and provides the receiver 10 with the URL (step T3).

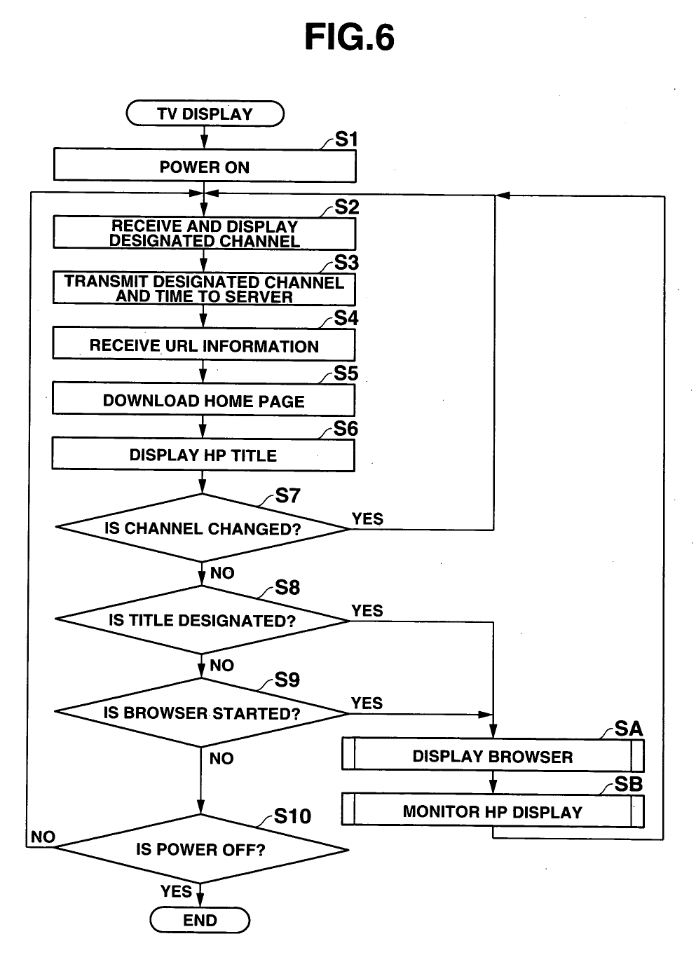

FIG. 6 is a flowchart showing a television display process of the digital television receiver 10 of the digital television receiving system described above.

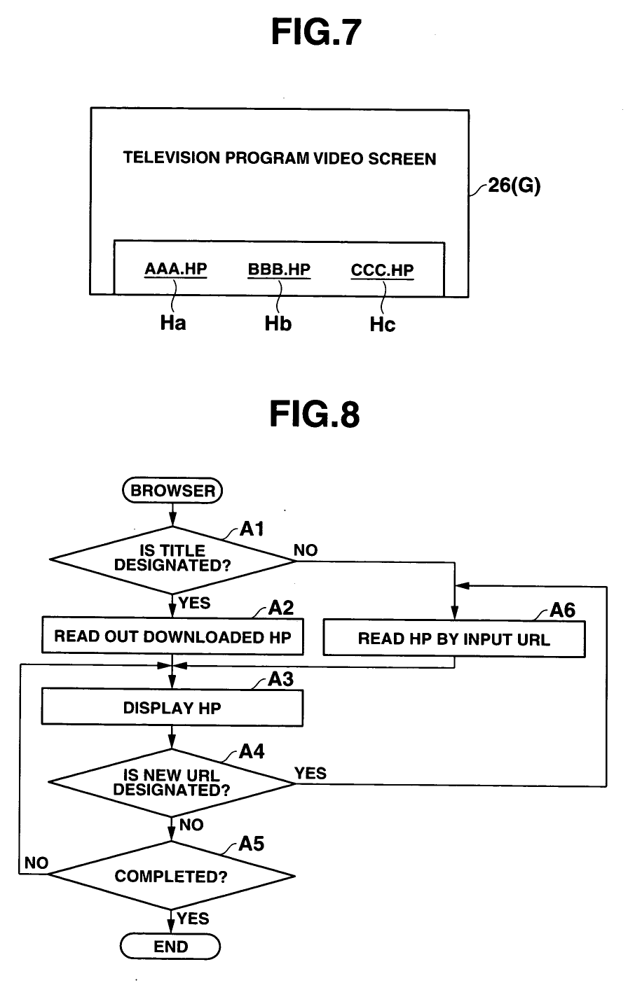

FIG. 7 is a chart showing a state of a broadcast program video screen G displayed by the television display process of the digital television receiver 10.

When the digital television'receiver 10 is powered on by the operation of an ON/OFF key of the input unit 30 (step S1), a broadcast program of a channel designated by the operation of a channel key is received by the digital broadcast receiving unit 23. The received program is displayed as a broadcast program video screen G on the display unit 26 via the image processing unit 25 and output as a program voice from the speaker 28 via the voice processing unit 27 (step S2).

Then, the current designated (received) channel stored in the designated-channel memory 22b and the present time measured by a time measuring unit incorporated in the control unit 21 are transmitted to the URL providing server 13 on the Internet N (step S3).

Then, the URL providing server 13 provides the digital television receiver 10 with the URL information of a Web site relevant to a broadcast program that a user is watching, on the basis of the URL information 15a (steps T2 and T3 in FIGS. 4 and 5) stored in the shared database 15 (step S4). The URL information is stored in the URL information memory 22c and the Web sites (servers) 12A, 12B and 12C corresponding to the URL information are accessed. Data of the home pages (HP) of the Web sites is downloaded (step S5) and stored in the download HP memory 22d.

HP titles Ha, Hb and Hc of the Web sites stored in the download HP memory 22d are displayed on the lower part of the broadcast program video screen G (step S6), as shown in FIG. 7.

When it is determined that a user operates the channel key of the input unit 30 to change the designated channel (step S7), the process of the steps S2 to S6 is performed again in accordance with the changed designated channel, and the HP titles Ha, Hb and Hc of the Web sites are displayed on the lower part of the broadcast program video screen G of the changed channel.

If it is determined that one of the HP titles Ha, Hb and Hc is designated by operating a combination of, e.g., the cursor key and enter/execution key of the input unit 30 (step S8) or if it is determined that the user gives an instruction to connect the digital television receiver 10 to the Internet to start up a browsing program (step S9), the flow shifts to the browser display process (step SA) shown in FIG. 8.

FIG. 8 is a flowchart showing a browser display process (step SA) accompanying the television display process of the digital television receiver 10.

In the browser display process (step SA), if it is determined that one of the HP titles is designated by the user's operation in step S8 (step A1), data of the HP corresponding to the designated HP title is read out of the download HP memory 22d (step A2) and displayed on the display unit 26 (step A3).

Thus, a user can selectively designate and display the HP data of each of the Web sites relevant to a broadcast program that the user is watching.

After that, if it is determined that one of the URLs of a new Web site is designated as the user operates the input unit 30 (step A4), data of an HP corresponding to the designated one of the URLs is read in (step A6) and displayed on the display unit 26 (step A3).

If it is determined that the user gives an instruction to connect the digital television receiver 10 to the Internet to start up a browsing program in accordance with a user's operation in step S9, a Web site corresponding to the user's input URL is accessed to read data of the HP (step A1→step A6) and display the data on the display unit 26 (step A3).

If it is determined that one URL of a new Web site is designated (step S4), data of the HP corresponding to the designated URL is read in (step A6) and displayed on the display unit 26 (step A3).

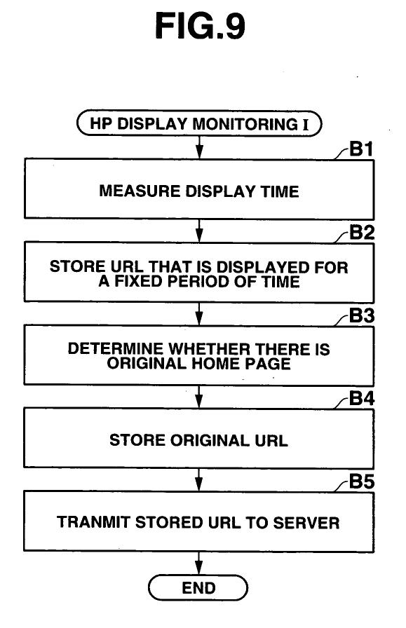

After that, if it is determined that the user gives an instruction to complete the display of an HP of a Web site relevant to the broadcast program that the user is watching (step A5), the flow shifts to the HP display monitoring process shown in FIG. 9 (step SB).

FIG. 9 is a flowchart of the HP display monitoring process (step SB), which accompanies the television display process of the digital television receiver 10.

When the browsing of an HP of a Web site relevant to a broadcast program that a user is watching is completed, a time period for which the HP is displayed and browsed is acquired and measured from the communication history recorded in the memory 22 (step B1). If the HP is displayed and browsed for longer than a give time period, its URL is extracted and stored in the fixed-time display URL memory 22f (step B2).

If there is the original home page from which the user jumps to a plurality of home pages with reference to a browser history, the home page is stored in the start origin HP/URL memory 22g (step B4).

Then, the URL of an HP displayed and browsed on the step B3 and B4 and stored in the fixed-time display URL memory 22f in steps B3 and B4, and the URL of the start origin HP registered in the HP/URL memory 22g is read out and transmitted to a the collecting server 14 (step B5).

In the television display process of the digital television receiver 10, the URLs of HPs of Web sites relevant to a broadcast program that a user is watching are acquired from the URL providing server 13. The data of the HPs is downloaded and the tiles of the HPs are displayed on the broadcast program video screen G. If the titles of user's desired HPs are designated and the HPs are displayed and browsed, the URL of an HP, which has been displayed and browsed for longer than a given time period, and the URL of the original HP are extracted and transmitted to the collecting server 14. The collecting server 14 can thus collect URL information of an HP that is displayed and reliably browsed by the user of the digital television receiver 10 while the user is watching the program.

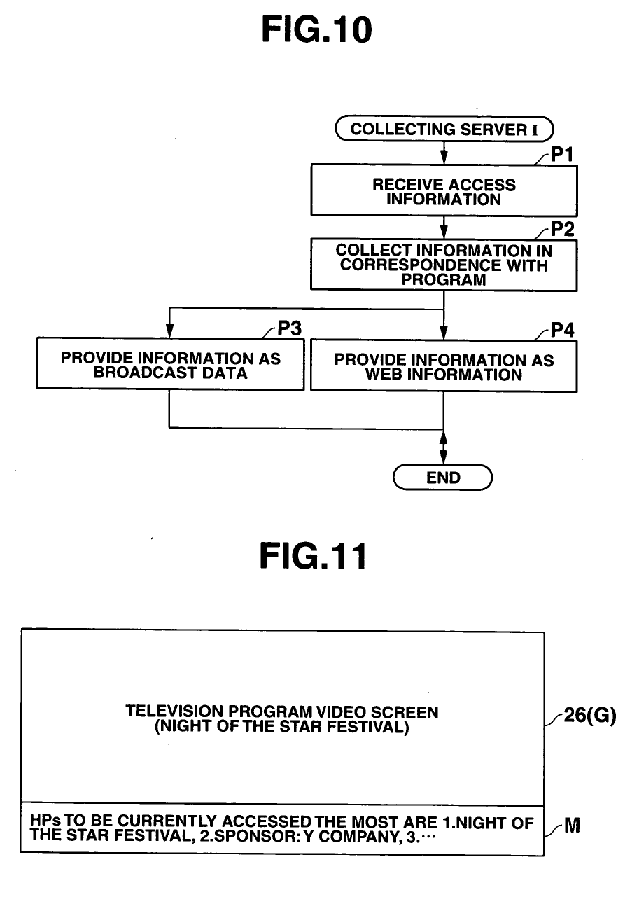

FIG. 10 is a flowchart of the collection process performed by the collecting server 14 of the digital television receiving system.

FIG. 11 is a chart of the broadcast program video screen G with a relevant HP access ranking message M created by the broadcast station 11 in accordance with the collection process performed by the collecting server 14 of the digital television receiving system.

The digital television receiver 10 transmits the URL information displayed and browsed while a user is watching a program in accordance with the HP display monitoring process (step SB) accompanying the television display process shown in FIGS. 6 to 9 (step P1). In the URL information 15a (FIG. 4) stored in the shared database 15, the number of times the user accesses the URL information of the program that the user is watching, is counted up and collected as the number of user access times the user accesses the HP of a Web site relevant to the program (step P2).

Thus, the collected URL information 15a is transmitted to the broadcast station 11. As shown in FIG. 11, the URL information 15a is displayed on the program video screen G of a program (e.g., “Night of the Star Festival”) on the air as message M (indicating that the HPs to be currently accessed the most are 1 . Night of the Star Festival, 2. Sponsor: Y company, 3. . . . ) of a user (audience) access ranking for the HPs of Web sites relevant to the program (step P3).

The collected URL information 15a is also provided in public as Web information (step P4). The audience can thus easily know the popularity stakes of the HPs of Web sites relevant to a program.

According to the above digital television receiving system according to the first embodiment, while an audience is watching a broadcast program on the digital television receiver 10 (10A, 10B and 10C) having a function of communicating with the Internet N, the URL providing server 13 distributes the URLs of Web sites relevant to the program, downloads their HP data, and displays the titles of HPs of the Web sites. In the URL information 15a stored in the shared database 15 of the URL providing server 13 and collecting server 14, the URL information of HPs designated and browsed by the audience is collected and recorded as the number of times the audience has accessed the URLs of Web sites relevant to the program, and then provided for the broadcast station 11. The collected URL information can thus be displayed on the program video screen G as audience access ranking for the Web sites relevant to the program and provided as Web information, with the result that the audience can acquire the URL information as popular ranking information on the Web sites relevant to the program. Consequently, the audience can easily know the popularity stakes of the Web sites relevant to the program and refer to the popularity stakes to open and browse the HPs of the Web sites.

According to the digital television receiving system described above, in accordance with the URLs of Web sites relevant to the program provided by the URL providing server 13, the HP data of the URLs is downloaded and the HP titles thereof are displayed on the program video screen G. If the displayed HP titles are designated by user's operation, the HP data can easily be displayed and browsed.

(Second Embodiment)

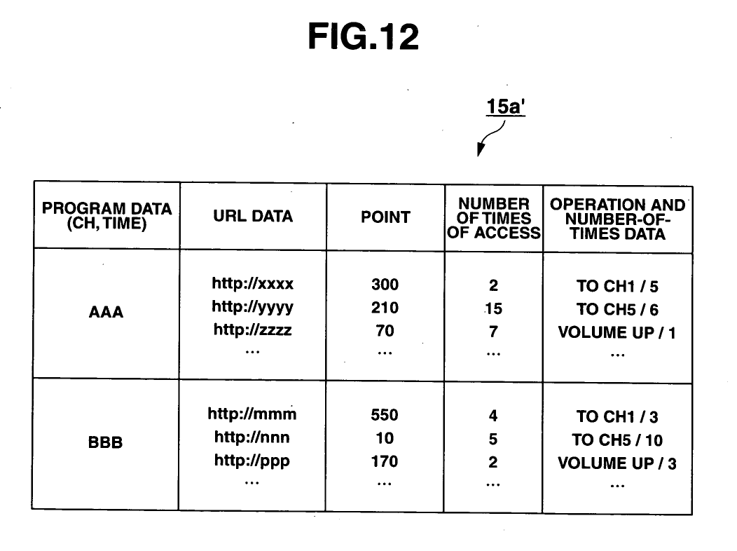

FIG. 12 is a table showing part of URL information and television operating information 15a′ of a broadcast program, which is sequentially updated and stored in a shared database 15 of a URL providing server 13 and a collecting server 14 in a digital television receiving system according to a second embodiment of the present invention.

The URL information and television operating information 15a′ includes the URL data (including HP titles) of Web sites relevant to a program, point data indicating the points of access to each of the HPs on the air, the number of times the audience gains access to each of the HPs, the audience's TV operations (change of channels, power-off, etc.) and their number-of-times data on the air. These data items correspond to program data based on the channel and airdate of a program to be broadcasted by a broadcast station 11. The program data based on the channel and airdate of a program and the URL data (including HP titles) of the Web sites are updated and recorded by the URL providing server 13 each time they are changed with the same information supplied from the broadcast station 11. The point data, the audience number-of-access times, the audience's TV operations and the number-of-times data are updated and recorded by the collecting server 14 on the basis of HP display browser information and TV operation information supplied from a digital television receiver 10 (10A, 10B and 10C).

The digital television receiving system of the second embodiment is the same as that of the first embodiment in the URL providing process (FIG. 5) and the browser display process (step SA: FIG. 8).

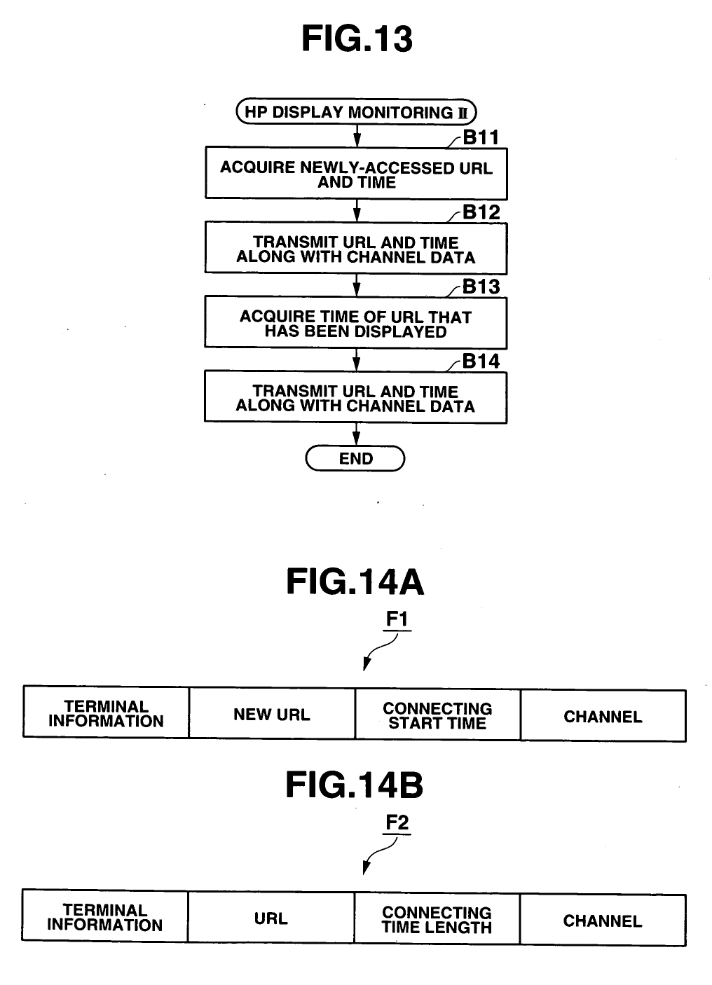

FIG. 13 is a flowchart showing an HP display monitoring process (corresponding to step SB in FIG. 6) accompanying a television display process of the digital television receiver 10.

FIGS. 14A and 14B are charts of transmission formats F1 and F2 of newly-browsing URL data and browsed URL data both of which are to be transmitted to the collecting server 14 in accordance with the HP display monitoring process.

When the HPs of Web sites relevant to a broadcast program are displayed and browsed through the browser display process of the receiver 10, the URL of an HP newly accessed through a networking unit 29 and the access start time (connection start time) measured by a built-in timer of a control unit 21 are acquired (step B11). As shown in FIG. 14A, together with channel data of the program obtained from a digital broadcast receiving unit 23, the URL and access start time are transmitted to the collecting server 14 as the transmission format F1 that corresponds to terminal identification information stored in advance in a memory 22 of the receiver 10 (step B12).

The URL of an HP that has been accessed and displayed through the networking unit 29 until another HP is newly accessed and the access time (connection time=present time−access start time) measured by the built-in timer are acquired (step B13). As shown in FIG. 14B, together with channel data of the program obtained from the digital broadcast receiving unit 23, the URL and access time are transmitted to the collecting server 14 as the transmission format F1 that corresponds to the terminal identification information (step B14).

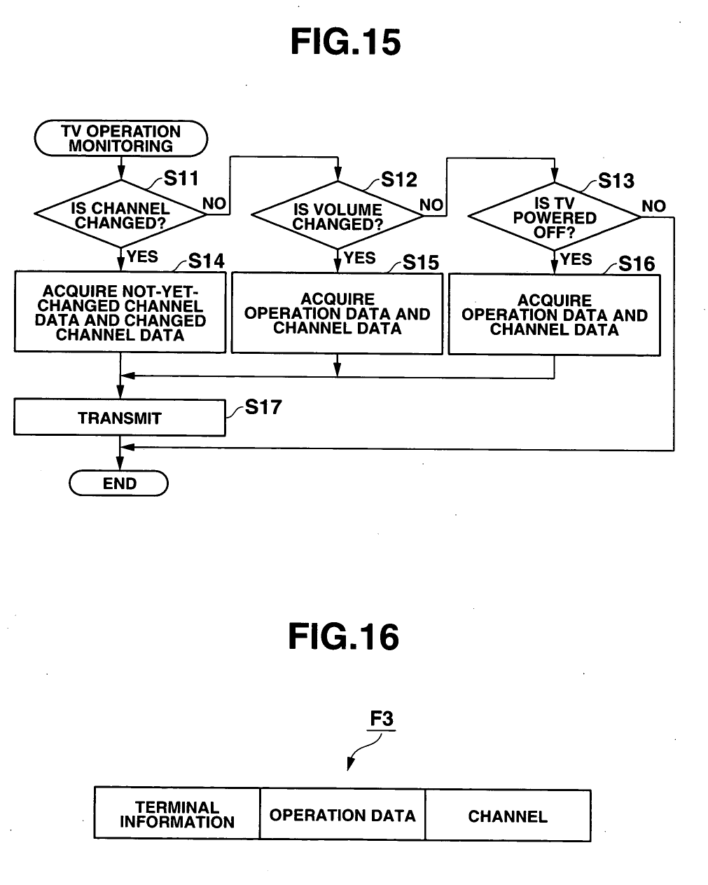

FIG. 15 is a flowchart showing a TV operation monitoring process started up concurrently with the television display process (corresponding to the process shown in FIG. 6) of the digital television receiver 10.

FIG. 16 is a chart of transmission format F3 of TV operation data to be transmitted to the collecting server 14 in accordance with the TV operation monitoring process of the digital television receiver 10.

If it is determined that the channel of a program that a user is watching on the digital television receiver 10 has been changed by operating an input unit 30 (YES in step S11), channel operation data of the not-yet changed channel and that of the changed channel are acquired (step S14). As shown in FIG. 16, together with the channel data of a program that a user is watching, the not-yet-changed channel data is transmitted to the collecting server 14 as the transmission format F3 corresponding to the terminal identification information stored in advance in the memory 22 (step S17).

If it is determined that the volume of the program is changed by operating the input unit 30 (YES in step S12), volume operation data and channel data of the program are acquired (step S15) and, as shown in FIG. 16, transmitted to the collecting server 14 as the transmission format F3 (step S17).

If it is determined that the receiver 10 is powered off by operating the input unit 30 (YES in step S13), operation data of the power-off and channel data of the program are acquired (step S16) and, as shown in FIG. 16, transmitted to the collecting server 14 as the transmission format F3 (step S17).

The collecting server 14 can collect URL information of HPs browsed by users who are watching programs on the receivers 10A, 10B and 10C, time periods for browsing the HPs, and television operation information through the HP display monitoring process shown in FIG. 13 and the TV operation monitoring process shown in FIG. 15.

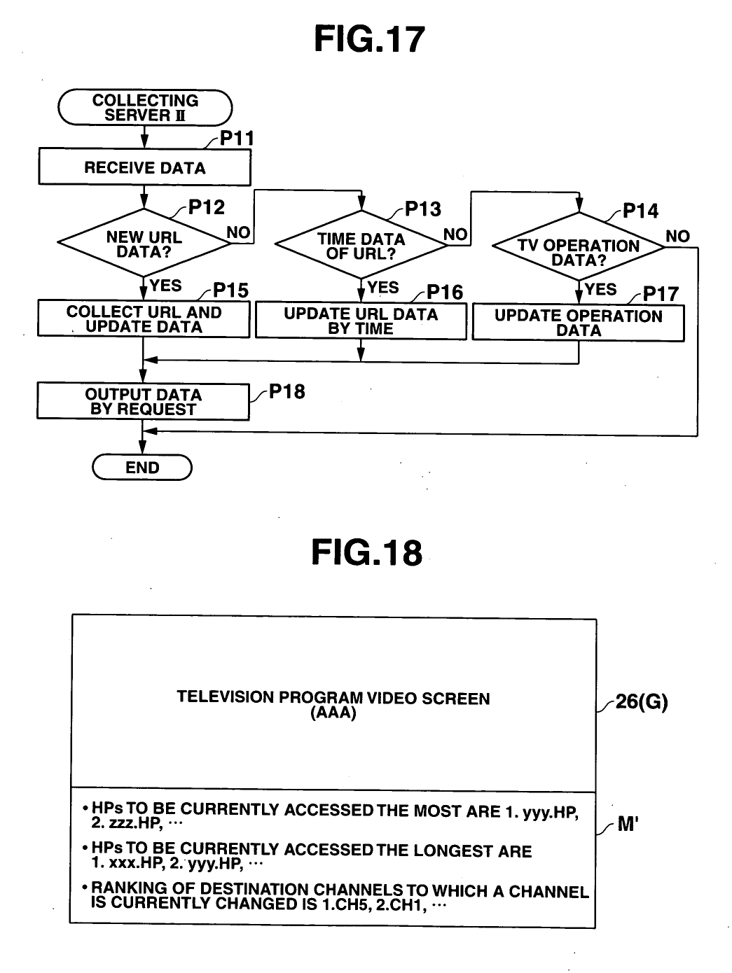

FIG. 17 is a flowchart showing a collection process of the collecting server 14 of the digital television receiving system according to the second embodiment.

FIG. 18 is a chart showing a broadcast program video screen G with a relevant HP access ranking and audience trend message M′ created by the broadcast station 11 in accordance with the collection process performed by the collecting server 14 of the digital television receiving system.

In accordance with the HP display monitoring process (steps B11 to B14 in FIG. 13) and TV operation monitoring process (steps S11 to S17 in FIG. 15), the displayed browser URL information of a program and TV operation information are received from the digital television receiver 10 (10A, 10B and 10C) (step P11). It is determined that the received information is the newly-browsing URL data represented as the transmission format F1 shown in FIG. 14A or the browsed URL data represented as the transmission format F2 shown in FIG. 14B or the TV operation data represented as the transmission format F3 shown in FIG. 16 (steps P12 to P14 in FIG. 17).

If it is determined that the received information is the newly-browsing URL data (YES in step P12), browser points (e.g., 20 points), which correspond to the newly-browsing URL data and program data corresponding to the channel and time of a program, are added to the URL information and television operating information 15a′ stored in the shared database 15, and the number of times the users gain access to the newly-browsing URL data is counted up and updated (step P15).

If it is determined that the received information is the browsed URL data (YES in step P13), connection (browsing) time points (e.g., one point per three minutes), which correspond to the newly-browsing URL data and program data corresponding to the channel of a program that a user is watching, are added to the URL information and television operating information 15a′ and updated (step P16).

If it is determined that the received information is the TV operation data (YES in step P14), the TV operation data is written to the URL information and television operating information 15a′ as data corresponding to program data corresponding to the channel of a program that a user is watching, and the number of times is counted up and updated (step P17). When the TV operation data indicates a change in channel, it is written as, for example, “ch1.” When the data indicates a change in volume, it is written as, for example, “Vol-Up.” When the data indicates power-off, it is written as “TV OFF.”

If the URL information and television operating information 15a′ stored in the shared database 15 is collected and updated in accordance with the process of steps P11 to P17, the collected URL information and information 15a′ are transmitted to the broadcast station 11. As shown in FIG. 18, the collected information is displayed on the program video screen G of a program (AAA) on the air as a user (audience) access ranking and message M′ for the HPs of Web sites relevant to the program (step P18). For example, the message M'indicates the following: the HPs to be currently accessed the most are 1. yyy. HP, 2. zzz. HP, . . . , the HPs to be currently accessed the longest are 1. xxx. HP, 2. yyy. HP, . . . , and the ranking of destination channels to which a channel is currently changed is 1. ch5, 2. ch1,

The collected information 15a′ is also provided in public as Web information (step P18). The audience can thus easily know the popularity stakes of the HPs of Web sites relevant to a program and the trends in the audience (channel destinations, etc.).

According to the digital television receiving system according to the second embodiment, the collecting server 14 acquires and collects not only the URL information of HPs browsed by users who are watching a broadcast program, but also television operation information (trends in audience) of the users. The collected information is transmitted to the broadcast station 11 or provided in public as Web information. The audience can thus easily know the popularity stakes of the HPs of Web sites relevant to a program and the frequency of changes to a program at the same time on a different channel, based on which the audience can open and browse the HPs of the Web sites and watch another program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital television receiving system including a television receiver having an Internet connecting function and a server on the Internet,
the television receiver comprising:
information transmitting means for transmitting information of a television program that a user is watching, to the server; and
URL transmitting means for transmitting a URL of a Web site accessed by the user using the Internet connecting function while the user is watching the television program, to the server, and
the server comprising:
information receiving means for receiving the information that is transmitted to the server from the information transmitting means of the television receiver;
URL receiving means for receiving the URL that is transmitted to the server from the URL transmitting means of the television receiver;
access URL collecting means for collecting the URL received by the URL receiving means in correspondence with program information based on the information received by the information receiving means; and
collection result outputting means for outputting a collection result of URLs collected by the access URL collecting means for each program information.

2. The digital television receiving system according to claim 1, wherein:
the server further comprises:
program-to-program URL storing means for storing a URL of a Web site relevant to each of a plurality of programs; and
relevant URL providing means for providing the television receiver with the URL of the Web site stored in the program-to-program URL storing means in correspondence with program information based on the information received by the information receiving means, and
the television receiver further comprises:
relevant URL receiving means for receiving the URL provided by the relevant URL providing means of the server; and
HP title display control means for displaying a title of a home page of a Web site relevant to a television program that a user is watching in accordance with a URL of the Web site, which is received by the relevant URL receiving means, on a screen of the television program.

3. The digital television receiving system according to claim 2, wherein the HP title display control means of the television receiver includes HP downloading means for downloading the home page of the Web site in accordance with the URL of the Web site, and displays a title of the home page downloaded by the HP downloading means on the screen of the television program.

4. The digital television receiving system according to claim 3, wherein the television receiver further comprises:
HP title designating means for designating the title of the home page of the Web site displayed on the screen of the television program by the HP title display control means in accordance with a user's operation; and
HP display control means for displaying the home page downloaded by the HP downloading means in accordance with the title of the home page designated by the HP title designating means, and
the URL of the Web site transmitted to the server from the URL transmitting means is a URL of the home page displayed by the HP display control means.

5. The digital television receiving system according to claim 4, wherein:
the URL of the Web site transmitted to the server from the URL transmitting means includes a URL of the home page displayed by the HP display control means and a time period for which the home page is displayed; and
the access URL collecting means of the server collects the URL received by the URL receiving means and a time period for which a home page of the URL is displayed.

6. The digital television receiving system according to claim 1, wherein:
the television receiver further comprises television operating information transmitting means for transmitting television operating information of the television receiver on which the user is watching the television program, to the server;
the server further comprises television operating information receiving means for receiving the television operating information from the television operating information transmitting means of the television receiver;
the access URL collecting means collects the URL received by the URL receiving means and the television operating information received by the TV operating information receiving means; and
the collection result outputting means outputs a collection result of an URL for each program information collected by the access URL collecting means and the television operating information of the television receiver.

7. The digital television receiving system according to claim 1, wherein the program information includes a broadcast channel, broadcast time and a program title which correspond to one another, and the received information includes a received channel and present time which correspond to each other.

8. A television receiver having an Internet connecting function, comprising:
information transmitting means for transmitting information of a television program that a user is watching, to a server on the Internet; and
URL transmitting means for transmitting a URL of a Web site accessed by the user using the Internet connecting function while the user is watching the television program, to the server on the Internet.

9. The television receiver according to claim 8, further comprising:
relevant URL receiving means for receiving a URL of a Web site relevant to a television program that a user is watching, which is transmitted from the server when the information transmitting means transmits the information;
HP title display control means for displaying a title of a home page of the Web site in accordance with the URL of the Web site, which is received by the relevant URL receiving means, on a screen of the television program;
HP title designating means for designating the title of the home page of the Web site displayed on the television program by the HP title display control means in accordance with a user's operation; and
HP display control means for displaying a home page downloaded from the Internet in accordance with the title of the home page designated by the HP title designating means, and
the URL of the Web site transmitted to the server from the URL transmitting means is a URL of the home page displayed by the HP display control means.

10. The television receiver according to claim 9, wherein the URL transmitted to the server from the URL transmitting means includes a URL of the home page displayed by the HP display control means and a time period for which the home page is displayed.

11. The television receiver according to claim 8, further comprising television operating information transmitting means for transmitting television operating information of the television receiver on which the user is watching the television program, to the server.

12. A server to which a television receiver is connected, the television receiver including information transmitting means for transmitting information of a television program to the server on the Internet while a user is watching the television program and URL transmitting means for transmitting a URL of a Web site accessed by the user while the user is watching the television program, to the server on the Internet, the server comprising:
information receiving means for receiving information from the information transmitting means of the television receiver;
URL receiving means for receiving the URL that is transmitted to the server from the URL transmitting means of the television receiver;
access URL collecting means for collecting the URL received by the URL receiving means in correspondence with program information based on the information received by the information receiving means; and
collection result outputting means for outputting a collection result of URLs collected by the access URL collecting means for each program information.

13. The server according to claim 12, wherein:
the URL of the Web site transmitted to the server from the URL transmitting means of the television receiver includes the URL of the Web site accessed while the user is watching the television program and a time period for which a home page of the URL is displayed; and
the access URL collecting means collects the URL received by the URL receiving means and a time period for which a home page of the URL is displayed.

14. The server according to claim 12, wherein:
the television receiver further comprises television operating information transmitting means for transmitting television operating information of the television receiver on which the user is watching the television program;
the server further comprises television operating information receiving means for receiving the television operating information from the television operating information transmitting means of the television receiver;
the access URL collecting means collects the URL received by the URL receiving means and the television operating information received by the TV operating information receiving means; and
the collection result outputting means outputs a collection result of URLs for each program information collected by the access URL collecting means and the television operating information of the television receiver.
